(19) United States
(12) Patent Application Publication
(10) Pub. No.: US 2005/0166240 A1
(43) Pub. Date: Jul. 28, 2005

(54) Display system and control method thereof

(75) Inventor: Hee Jin Kim, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/024,671

(22) Filed: Dec. 30, 2004

(30) Foreign Application Priority Data
Jan. 2, 2004 (KR) P2004-0074

(51) Int. Cl. H04N 5/268; H04N 5/44

(52) U.S. Cl. 725/78; 348/734

(57) ABSTRACT

A display system for controlling a display according to inclinations and preferences of users and a control method thereof are provided. In the display system, a display periodically outputs a request signal and is driven according to at least one response signal received in response to the request signal, and one or more remote controllers transmit the response signal containing control information for controlling the display and set IDs to the display in response to the request signal.

This application claims the benefit of the Korean Patent Application No. P2004-00074 filed on 2 Jan. 2004, which is hereby incorporated by reference.

### BACKGROUND OF THE INVENTION

1. Field of the Invention

The present invention relates to a display system, and more particularly, to a display system for a plurality of users and a control method thereof.

2. Discussion of the Related Art

Generally, a television (TV) receives a broadcast signal from a broadcasting station, converts the received broadcast signal into video/audio signals, and provides the video/audio signals to viewers. Recently, most homes have one or more TVs, and a plurality of viewers in one home view a broadcast program by using at least one TV. Since viewers prefer different genres of program or want different additional functions, it is inevitably inconvenient for a plurality of viewers to use only one TV. For example, an auto on/off function cannot simultaneously satisfy a plurality of viewers. Also, in case of a function for storing a user's preference program in a TV, the TV cannot stores all the preference programs requested by various viewers.

### SUMMARY OF THE INVENTION

Accordingly, the present invention is directed to a display system and a control method thereof that substantially obviates one or more problems due to limitations and disadvantages of the related art.

An object of the present invention is to provide a display system and a control method thereof for controlling a display according to inclinations and preferences of users.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display system includes: a display driven according to at least one response signal received in response to the request signal, the display periodically outputting a request signal; and one or more remote controllers for transmitting the response signal containing control information for controlling the display and set IDs to the display in response to the request signal.

The display may determine priorities of the IDs of the remote controllers based on stored priority information, and may be driven according to the control information corresponding to a highest priority ID out of received IDs. Also, the display may be turn on or off according to whether or not the response signal is received.

The control information may include one or more display options or functions selected by a user. The selected functions may include at least one of an auto-on/off function, a function for storing a user's preference channel and a function for limiting a broadcast view according to age.

In another aspect of the present invention, a display system includes: one or more remote controllers for outputting a pre-stored ID in response to a received request signal; and a display receiving one or more IDs responding to the request signal outputted therefrom and driven according to pre-stored control information corresponding to a high priority ID out of the received IDs.

The display may generate the control information based on one or more options or functions selected by a user. The display may include: a memory for control information corresponding the received IDs; and a controller for determining priorities of the received IDs.

In a further aspect of the present invention, a method for controlling a display, includes the steps of: transmitting a request signal from the display to one or more remote controllers; transmitting control information for controlling the display and set IDs from the remote controllers to the display in response to the request signal; and driving the display based on the transmitted control information.

The step of driving the display base on the control information may include the step of driving the display according to the control information corresponding to a highest priority ID out of the transmitted IDs.

The method may further include the steps of: selecting one or more options or functions of the display from a menu displayed on the display by using the remote controller; generating the control information based on the selected option or function; and transmitting the generated control information from the display to the corresponding remote controller.

The method may further include the steps of: selecting one or more options or functions of the display from a menu displayed on the remote controller; generating the control information based on the selected option or function; and storing the generated control information in the remote controller.

In a further another aspect of the present invention, a method for controlling a display, includes the steps of: transmitting a request signal from the display to one or more remote controllers; transmitting pre-stored IDs from the remote controllers to the display in response to the request signal; determining a highest priority ID out of the transmitted IDS; and driving the display based on pre-stored control information corresponding to the highest priority ID.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a display system according to an embodiment of the present invention;

FIGS. 2A and 2B are flow diagrams illustrating a method for controlling a display system according to an embodiment of the present invention;

FIG. 3 is a diagram illustrating a control information set menu according to an embodiment of the present invention;

FIGS. 4A and 4B are diagrams illustrating a control option menu according to an embodiment of the present invention; and

FIGS. 5A and 5B are flow diagrams illustrating a method for controlling a display system according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

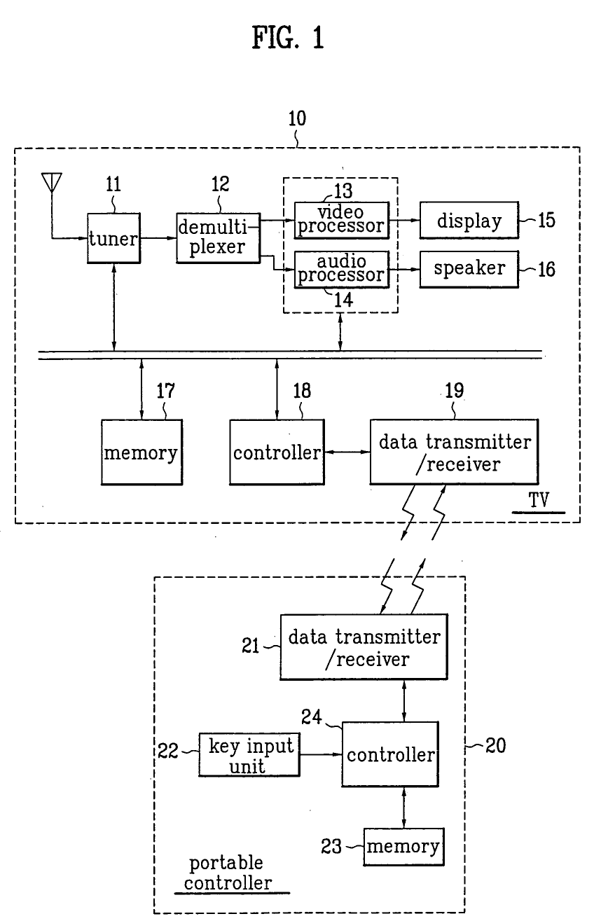

FIG. 1 is a block diagram of a display system according to an embodiment of the present invention.

Referring to FIG. 1, the display system includes a display 10 (such as a TV) for displaying a broadcast program and one or more remote controllers 20.

In the display 10, a tuner 11 selects a broadcast signal, a demultiplexer 12 divides the broadcast signal into a video signal, an audio signal and additional information. The video signal is converted into a displayable signal by a video processor 13, and the converted displayable signal is displayed on a display unit 15. The audio signal is converted by an audio processor 14 and outputted through a speaker 16. The additional information is stored in a memory 17 by a controller 18. A data transmitter/receiver 19 of the display 10 periodically outputs a request signal for determining whether or not the remoter controller 20 exists within a communication-possible range. The controller 18 receives a response signal for the request signal from the remote controller 20, and perceives the remote controller 20 based on the received response signal. The response signal includes an ID or an serial number assigned to the remote controller 20. Also, the controller 18 controls the display 10 according to control information corresponding to an ID or a serial number assigned to the perceived remote controller 20. The control information includes a display option and information related to additional functions. The display option includes a contrast, a color, brightness, a hue, and the like. The additional functions include an auto-on/off function, a function for storing a user's preference channel (or a genre or a program) and a function for limiting a broadcast view according to age, and so on.

The remote controller 20 includes a key input unit 22 having various function keys, a data transmitter/receiver 21 for exchanging data with the display 10, a memory 23 for storing IDs or serial numbers, and a controller 24 for controlling the data transmitter/receiver 21 to transmit an instruction signal of a user or the response signal. The remote controller may further include a display unit (not shown) for displaying control information. The remote controllers 20 may be respectively assigned to a plurality of users viewing the one display 10. The remote controller may be a portable type of a wristwatch or a necklace, or may be include in a mobile terminal such as a portable phone, a PDA, and the like. The remote controller 20 receives a request signal from the display 10, and transmits a response signal for the request signal to the display 10.

Reference will now be made in detail to a method for controlling the display system according to the present invention.

### First Embodiment

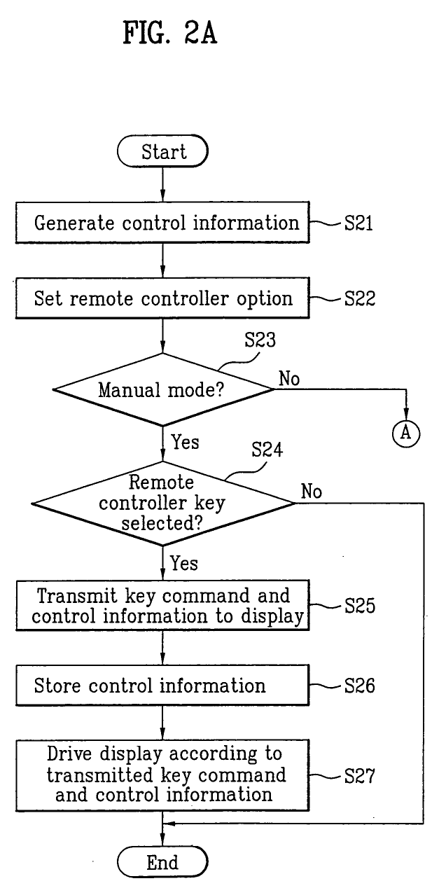

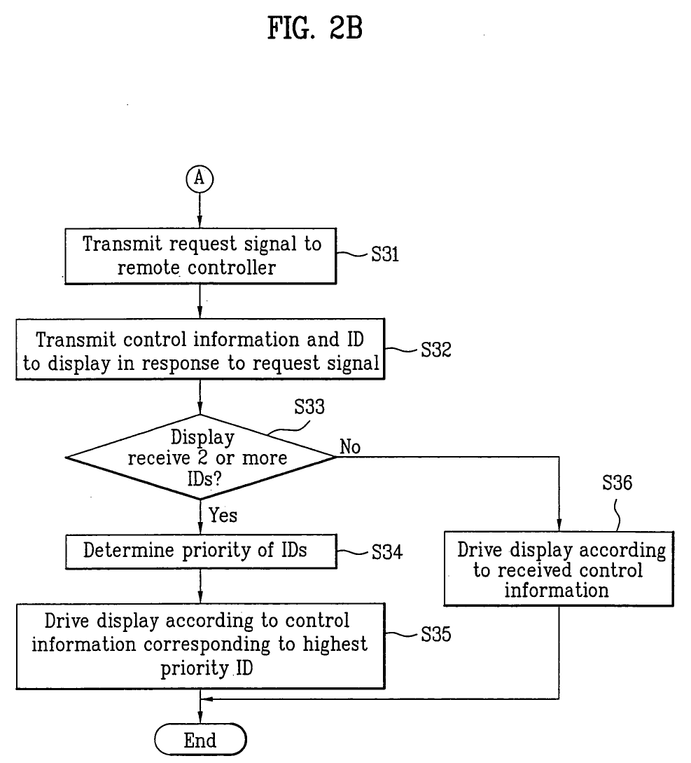

FIGS. 2A and 2B are flow diagrams illustrating a method for controlling a display system according to an embodiment of the present invention.

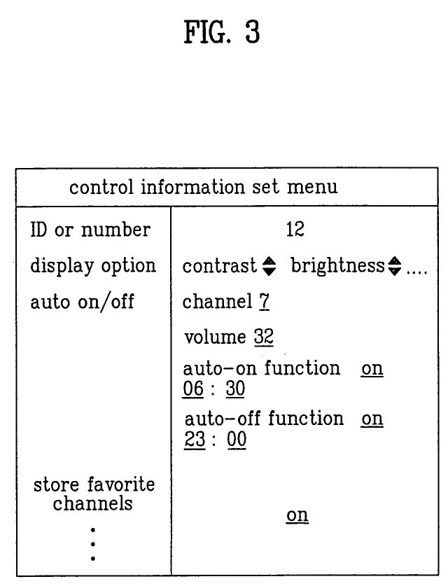

Referring to FIGS. 2A and 2B, when functions or options of the display 10 is set by one or more users, control information by the users are generated base on the functions or the options (S21). There are proposed two methods for generating the control information. One method is that the controller 18 of the display 10 generates the control information based on functions and options selected from a control information set menu shown in FIG. 3. When the controller 18 displays the control information set menu on a screen, a user inputs his ID or a serial number of the remote controller 20 into the control information set menu, and selects various functions and options of the display 10. For example, a user can select a display option, an auto-on/off function, a preference channel storage function, and the like. Then, the controller 18 generates the control information based on the functions and the options selected from the control information set menu. When the control information is generated, the display 10 transmits the control information to the corresponding remote controller 20. The transmitted control information is stored in the memory of the remote controller 20.

Another method is that the remote controller 20 generates the control information. A user can select various functions and options of the display 10 by using a menu displayed on a display unit (not shown) of the remote controller 20. The controller 24 generates control information based on the selected functions and options. The generated control information is stored in the memory 23 of the remote controller 20.

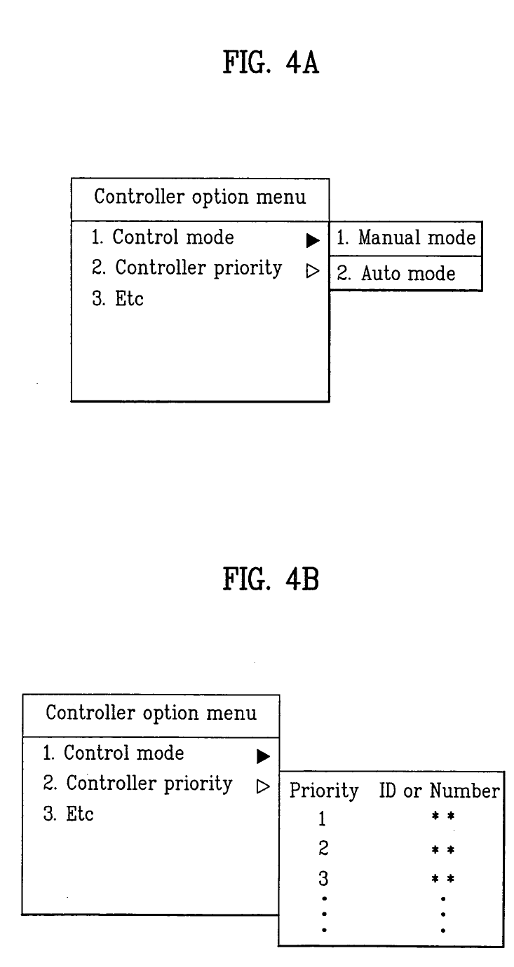

The user selects options for the remote controller 20 by using a controller option menu displayed on a screen of the display 10 (S22). For example, as shown in FIG. 4A, the user sets a control mode by using the control option menu. The control mode includes a manual mode and an auto mode. If the manual mode is selected, the display 10 is operated according to an instruction signal outputted from the remote controller 20. Otherwise, if the auto mode is selected, the display 10 is automatically operated according to the control information stored in the remote controller 20. Also, as shown in FIG. 4B, users set an priority order of the users by using the controller option menu. The users' priority order is a criterion for determining which has the highest priority among instruction signals simultaneously outputted from two or more remote controllers 20. The set priority order is stored in the memory 17 of the display 10.

The display 10 is operated differently according to the control modes. That is, the display 10 is operated differently according to a manual mode of an auto mode. The controller 18 identifies whether the manual mode of the auto mode is selected (S23). If the manual mod is selected, the controller 18 controls elements of the display 10 according to an instruction signal received from the remote controller 20. The remote controller 20 determines whether or not a specific key is selected by a user (S24). If the specific key is selected, the remote controller transmits a command signal corresponding to the selected key to the display 10, together with the stored control information and the ID (S25). The display 10 determines whether or not the command signal is outputted from the remote controller 20, and if the command signal is received, stores the control information received together with the control signal in the memory 17 (S26). The controller 18 then determines whether or not the display 10 is in an off state (or a standby mode). If the display 10 is in an off state, the controller 18 turns on the display 10 and performs functions corresponding to the received command signal based on the stored control information (S27).

Otherwise, if the auto mode is selected, the display 10 periodically outputs a request signal as shown in FIG. 2A so as to perceive the remote controllers 20 within a communication-possible range (S31). The remote controller 20 within the communication-possible range receives the request signal, respectively generates a response signal for the request signal, and transmitted the generated response signal to the display 10 (S32). The response signal includes IDs, serial numbers and control information stored in the memory 23.

The display 10 determines whether or not the response signal is received. If the response signal is received from the remote controller 20, the display stores the control information contained in the response signal in the memory 17. The display 10 determines the number of the remote controllers 20 within the communication-possible range based on the received response signals (S33). If the display 10 receives the response signals from 2 or more remote controllers 20, it detects the IDs and the serial numbers from the response signals, and identifies a priority order of the users corresponding to the detected IDs or serial numbers based on the controller option stored in the memory 17 (S34). The display 10 can determine the remote controller 20 having the highest priority by using the detected IDs or serial numbers. The display 10 extracts the control information from the response signal received from the remote controller having the highest priority and stores the extracted control information. The display is then operated according to the control information of the remote controller having the highest priority (S35). The display 10 ascertains options or functions contained in the control information, and is operated according to the ascertained options or performs the ascertained functions. For example, if the control information contains an auto on/off function; the display is automatically turned on/off at the set time.

If a plurality of remote controllers 20 exit within the communication-possible range, the display 10 is operated according to the control information and the command signal outputted from the highest priority remote controller 20. If the highest priority remote controller 20 gets out of the communication-possible range, the display 10 is operated according to control information and a command signal outputted from the next priority remote controller 20.

Also, if only one remote controller 20 exists within the communication-possible range, the display 10 is operated according to control information outputted from the remote controller 20 (S36). If the remote controller 20 gets out of the communication-possible range, the display 10 can be automatically turned off, and then can be turned on if the remote controller 20 enters the communication-possible range.

If no remote controllers 20 exits within the communication-possible range, the display 10 is not operated according to the pre-set options or functions. For example, if no remote controllers 20 exits within the communication-possible range, the display does not perform the auto on/off function even though an auto on/off function has been set.

### Second Embodiment

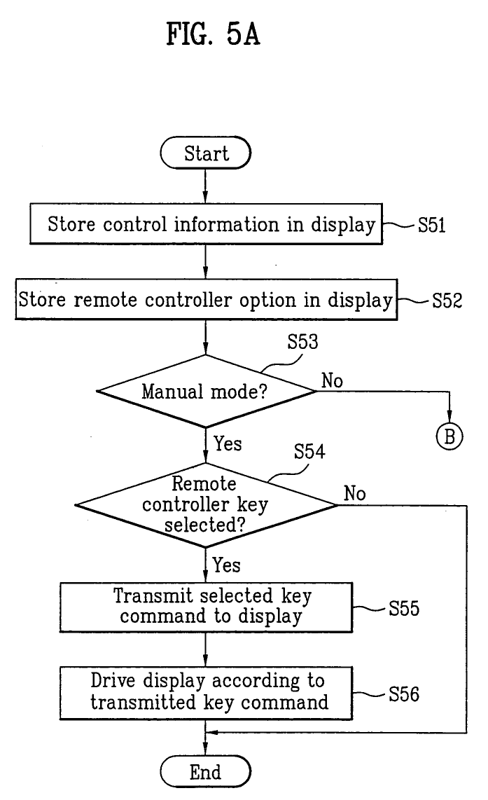

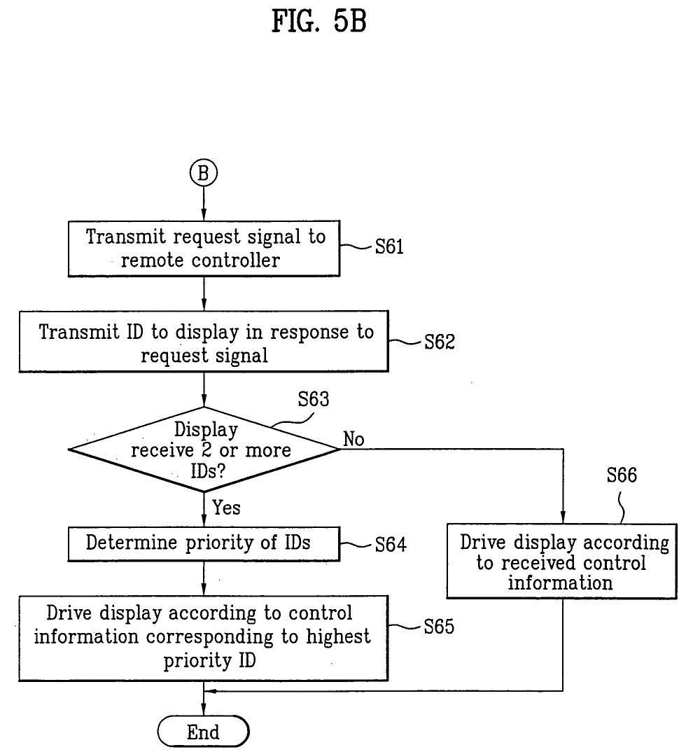

FIGS. 5A and 5B are flow diagrams illustrating a method for controlling a display system according to another embodiment of the present invention.

Referring to FIGS. 5A and 5B, when functions or options of the display 10 is set by one or more users, control information by the users are generated base on the functions or the options (S51). The control information is generated by the display 10 or the remote controller 20 as illustrated in the first embodiment. When the control information is generated, the controller 18 stores the generated control information in the memory 17 (S52).

A user can set a controller option by using a controller option menu displayed on a screen of the display 10. The controller option includes a control mode, a priority order of users, and the like. The control option is stored in the memory 17.

The display 10 is operated differently according to the control modes. That is, the display 10 is operated differently according to a manual mode of an auto mode. The controller 18 identifies whether or not the manual mode of the auto mode is selected (S53). If the manual mod is selected, the controller 18 controls elements of the display 10 according to an instruction signal received from the remote controller 20. The remote controller 20 determines whether or not a specific key is selected by a user (S54). If the specific key is selected, the remote controller transmits a command signal corresponding to the selected key to the display 10, together with the stored control information and the ID (S55). The display 10 determines whether or not the command signal is outputted from the remote controller 20, and if the command signal is received, performs functions corresponding to the received command signal (S56).

Otherwise, if the auto mode is selected, the display 10 periodically outputs a request signal as shown in FIG. 5B so as to perceive the remote controllers 20 within a communication-possible range (S61). The remote controller 20 within the communication-possible range receives the request signal, respectively generates a response signal for the request signal, and transmitted the generated response signal to the display 10 (S62). The response signal includes IDs, serial numbers and control information stored in the memory 23.

The display 10 determines whether or not the response signal is received. If the response signal is received from the remote controller 20, the display 10 determines the number of the remote controllers 20 within the communication-possible range based on the received response signals (S63). If the display 10 receives the response signals from 2 or more remote controllers 20, it detects the IDs and the serial numbers from the response signals, identifies a priority order of the users corresponding to the detected IDs or serial numbers based on the controller option stored in the memory 17, and determine the remote controller 20 having the highest priority by using the detected IDs or serial numbers (S64).

The display 10 reads the control information corresponding to the highest priority ID or serial number from the memory 17. The display is then operated according to the control information. The display 10 ascertains options or functions contained in the control information corresponding to the highest priority ID or serial number, and is operated according to the ascertained options or performs the ascertained functions (S65).

If a plurality of remote controllers 20 exit within the communication-possible range, the display 10 is operated according to the control information corresponding to the highest priority ID or serial number or the command signal outputted from the highest priority remote controller 20. If the highest priority remote controller 20 gets out of the communication-possible range, the display 10 is operated according to control information corresponding to the next priority ID or serial number or a command signal outputted from the next priority remote controller 20 (S66).

As described above, the present invention can automatically control the display system according to the options and functions set by respective users. Accordingly, the respective users can view an image or use additional functions according to their inclinations and preferences. Also, the display detects the user's remote controller, and is operated according to the set options and functions only when the remote controller exists within the communication-possible range. Accordingly, if a corresponding user does not exist, the set options or functions are not performed even when options or function are preset.

It will be apparent to those skilled in the art that various modifications and variations can be made in the present invention. Thus, it is intended that the present invention covers the modifications and variations of this invention provided they come within the scope of the appended claims and their equivalents.

1. A display system comprising:
a display driven according to at least one response signal received in response to the request signal, the display periodically outputting a request signal and; and
one or more remote controllers for transmitting the response signal containing control information for controlling the display and set IDs to the display in response to the request signal.

2. The system of claim 1, wherein the display determines priorities of the IDs of the remote controllers based on stored priority information.

3. The system of claim 2, wherein the display is driven according to the control information corresponding to a highest priority ID out of received IDs.

4. The system of claim 1, wherein the control information comprises one or more display options or functions selected by a user.

5. The system of claim 4, wherein the selected functions comprise at least one of an auto-on/off function, a function for storing a user's preference channel and a function for limiting a broadcast view according to age.

6. The system of claim 1, wherein the display is turn on or off according to whether or not the response signal is received.

7. A display system comprising:
one or more remote controllers for outputting a pre-stored ID in response to a received request signal; and
a display receiving one or more IDs responding to the request signal outputted therefrom and driven according to pre-stored control information corresponding to a high priority ID out of the received IDs.

8. The system of claim 7, wherein the display generates the control information based on one or more options or functions selected by a user.

9. The system of claim 8, wherein the control information comprises at least one of a display option, an auto-on/off function, a function for storing a user's preference channel and a function for limiting a broadcast view according to age.

10. The system of claim 7, wherein the display is turn on or off according to whether or not the ID is received.

11. The system of claim 7, wherein the display comprises:
a memory for control information corresponding the received IDs; and
a controller for determining priorities of the received IDs.

12. A method for controlling a display, comprising the steps of:
transmitting a request signal from the display to one or more remote controllers;
transmitting control information for controlling the display and set IDs from the remote controllers to the display in response to the request signal; and
driving the display based on the transmitted control information.

13. The method of claim 12, further comprising the step of determining priorities of the transmitted IDs based on priority information stored in the display.

14. The method of claim 12, wherein the step of driving the display base on the control information comprises the step of driving the display according to the control information corresponding to a highest priority ID out of the transmitted IDs.

15. The method of claim 12, further comprising the steps of:
selecting one or more options or functions of the display from a menu displayed on the display by using the remote controller;
generating the control information based on the selected option or function; and
transmitting the generated control information from the display to the corresponding remote controller.

16. The method of claim 12, further comprising the steps of:
selecting one or more options or functions of the display from a menu displayed on the remote controller;
generating the control information based on the selected option or function; and
storing the generated control information in the remote controller.

17. The method of claim 12, wherein the control information comprises at least one of a display option, an auto-on/off function, a function for storing a user's preference channel and a function for limiting a broadcast view according to age.

18. A method for controlling a display, comprising the steps of:
transmitting a request signal from the display to one or more remote controllers;
transmitting pre-stored IDs from the remote controllers to the display in response to the request signal;
determining a highest priority ID out of the transmitted IDS; and
driving the display based on pre-stored control information corresponding to the highest priority ID.

19. The method of claim 18, wherein the step of determining the highest prior ID comprises the step of determining priorities of the transmitted IDs based on priority information stored in the display.

20. The method of claim 18, further comprising the steps of:
selecting one or more options or functions of the display from a menu displayed on the display; and
generating the control information based on the selected option or function.
